(19) United States
(12) Patent Application Publication
(10) Pub. No.: US 2018/0082774 A1
(43) Pub. Date: Mar. 22, 2018

(54) APPARATUS AND METHOD FOR INCORPORATING HIGH-FLUX-DENSITY MAGNETIC MATERIALS IN ELECTROMAGNETIC DEVICES

(71) Applicant: Weinberg Medical Physics, Inc., North Bethesda, MD (US)

(72) Inventors: Irving N. WEINBERG, North Bethesda, MD (US); Sahar JAFARI, North Bethesda, MD (US)

(21) Appl. No.: 15/709,030

(22) Filed: Sep. 19, 2017

Related U.S. Application Data
(60) Provisional application No. 62/397,617, filed on Sep. 21, 2016.

(51) Int. Cl. H01F 3/02; H01F 1/147; H01F 41/02; H02K 1/06

(52) U.S. Cl. CPC H01F 3/02; H01F 1/147; H02K 1/06; H01F 41/02; H01F 1/14775

(57) ABSTRACT

A device for use in electromagnetic devices and magnetic cores of transformers and motors decreases magnetic core loss thereby improving efficiency.

### CROSS-REFERENCE TO RELATED APPLICATION(S)

This application relies for priority on U.S. Provisional Patent Application Ser. No. 62/387,617, entitled “APPARATUS AND METHOD FOR INCORPORATING HIGH-FLUX-DENSITY MAGNETIC MATERIALS IN ELECTROMAGNETIC DEVICES,” filed on Sep. 21, 2016, the entirety of which being incorporated by reference herein.

### FIELD

Disclosed embodiments are directed, generally, to electromagnetic devices, whether medical, automotive, or otherwise.

### BACKGROUND

### SUMMARY

Disclosed embodiments may be used in electromagnetic devices and magnetic cores of transformers to decrease magnetic core loss. As such, disclosed embodiments may be incorporated in such devices and transformers to increase efficiency.

### BRIEF DESCRIPTION OF FIGURES

FIG. 1 illustrates an example of an embodiment of an apparatus containing at least one layer of magnetizable material and at least one layer of electrically-insulating material.

### DETAILED DESCRIPTION

For the purposes of this disclosure, the term “magnetic core” is defined as a collection of magnetizable material that can be used at least as part of the process of converting electrical to magnetic energy or vice versa as part of an electromagnetic device. The term “laminated magnetic core” is defined as intervening layers of magnetic material and insulating material. For the purpose of this disclosure, the terms “magnetic material” and “magnetic layer” are equivalent to the terms magnetizable material and magnetizable layer, respectively. The term “electromagnetic device” is defined as an apparatus for converting electricity and/or magnetic fields at one frequency into electricity at another frequency and/or for converting electrical energy into kinetic energy or vice versa. Examples of electromagnetic devices include transformers, transducers, sensors, electric motors and generators.

Soft magnetic materials are used extensively in electromagnets, motors, transformers and relays, where high magnetic flux density (“B”) is often an important requirement for efficient operation of the electromagnetic device. Transformers and electric motors often operate under Alternating Current (“AC”) conditions. At high AC frequencies, the transient magnetic fields at some locations in these devices induce unwanted electrical currents at other locations. That flowing of unwanted electrical currents wastes energy as heat. These unwanted electrical currents are called “eddy currents,” and the energy waste from these unwanted electrical currents is called “eddy current loss.”

With finite conductivity of magnetic material, current applied on the coil winding produces an eddy current in the core. Based on Lenz's law, an eddy current creates a magnetic field that opposes the magnetic field that created it, and thus eddy currents react back on the source of the magnetic field. This results in a decrease of the magnetic field efficiency and the phase shift of the field with respect to the current in the coil winding. As the eddy current circulates in the core, it produces a heating effect as well. This is normally an undesirable effect and is the basis of the eddy current loss.

This loss is negligible in Direct Current (DC) circuits as it will occur during circuit turn on and turn off duration only. However, in AC circuits, the eddy current will be flowing continuously, in alternate directions. Equation (1) is used to calculate classic eddy current loss:

$${P}_{ed} = \frac{{π}^{2} σ {d}^{2}}{6 ρ} {B}_{max}^{2} {f}^{2} \qquad ( 1 )$$

whereρ p is the electrical resistivity, d and σ are the thickness and the density of the magnetic material, respectively.

Silicon steel is a magnetizable alloy with high saturation magnetic flux density (“Bₛ”), i.e., about 2 T. Increasing silicon content to the alloy adds to the electrical resistivity and thus in accordance with equation (1) reduces core less. Unfortunately, adding silicon to the alloy causes the unwanted effects of increasing brittleness and reducing magnetization. Effectively this brittleness factor limits the thickness of core layers to more than 300 microns per layer. This trade-off in properties was described in the article by S Jafari et al. entitled: “Microstructural and magnetic properties study of Fe—P rolled sheet alloys”, published in the Journal of Magnetism and Magnetic Materials, vol. 358-359, pp 38-43 (2014) (incorporated by reference in its entirety).

Another way of reducing eddy current loss is to fabricate a magnetic core as a laminated stack of thin layers of magnetic materials, with electrical insulation between layers. From equation (1) we see that reducing the thickness of the magnetizable layer will reduce the eddy current loss. Thus, the use of very thin magnetic layers will reduce the eddy currents effect more than a magnetic core with thick layers. Laminated stacks have become the most common magnetic core for electric motors and transformers.

Examples of laminated cores include thin (30-micron-thick) layers of the iron-based amorphous alloy Metglas (an alloy of iron with boron and silicon). The relatively low saturation magnetic flux density of Metglas (1.5 T) results in low efficiency of the electromagnetic device.

In accordance with disclosed embodiments, an apparatus which may be used as an electromagnetic device or as part of an electromagnetic device, may include a magnetic core including at least one thin layer (optionally between 1 nanometer and 300 microns in thickness) of one or more magnetic materials with high magnetic flux density, e.g., greater than 1.7 T. Examples of such materials include micro/nano crystalline silicon steel, Fe, and Fe—P. Typical electrical motors utilize laminated cores with each layer at least 300 microns in thickness, because of the brittleness factor described above. One or more magnetic layers are insulated electrically from a nearby layer of magnetic material by at least one electrically-insulating layer (optionally between 1 nanometer and 300 microns in thickness). The purpose of the electrically-insulating layer is to decrease eddy current loss.

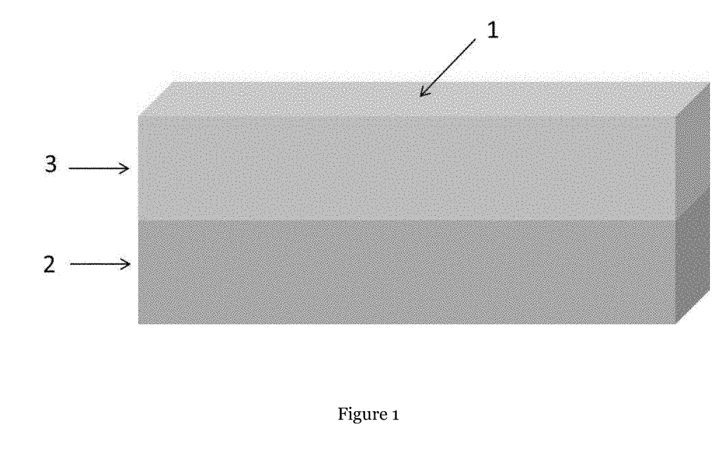

An example of such an apparatus is shown in FIG. 1 which illustrates an apparatus 1 containing at least one layer of magnetizable material 2 and at least one layer of electrically-insulating material 3. Use of such an apparatus enables the ability to reduce eddy current loss, and thereby increase the efficiency of a device as compared to conventional electrical systems.

Disclosed embodiments also provide a method of constructing a magnetic core, in which successive layers of magnetic material are deposited into the core, separated electrically by at least one electrically-insulating layer. That deposition can be accomplished with 3-D printing, in which the formation of more than one magnetic layers or of one or more electrically-insulating layers or of both types or layers is accomplished by depositing one or more raw forms (for example, in the raw form of a powder or liquid or gel or gas or chemical compound or a combination thereof) of the layers upon a surface and then solidifying the one or more layers through addition of energy (for example, in the form of light or heat or pressure or a combination thereof) after one or more deposition steps. Other deposition methods include evaporation.

In accordance with at least one embodiment, software and fast 3D printer technology may be used to automate the design, optimization, and combined manufacturing of electrical conductors (e.g., silver) and high-grade electrical insulators (e.g., Kapton, Ceramic insulators). Such operations may be performed under control of a controller within a manufacturing device.

Such a controller may be implemented in whole or in part using a computer processor that may be configured assist in performing operations, e.g., 3-D printing, described above. Accordingly, software code, instructions and algorithms utilized may be utilized by such a processor and may be stored in a memory that may include any type of known memory device including any mechanism for storing computer executable instructions and data used by a processor. Further, the memory may be implemented with any combination of read only memory modules or random access memory modules, optionally including both volatile and nonvolatile memory. Alternatively, some or all of the device computer executable instructions may be embodied in hardware or firmware (not illustrated). Further, it should be appreciated that, although not illustrated, the controller may similarly be coupled for communication and control to one or more user interfaces that may include display screens, one or more keyboards, and other types of user interface equipment.

In the article by J. P. Rigla et al. entitled: Design and Additive Manufacturing of MRI Gradient Coils, in proceedings of Nuclear Science Symposium and Medical Imaging Conference (NSS/MIC), 2014 (incorporated by reference in its entirety), the details of enabling 3-D printing method to manufacture such structures has been explained.

It is understood that the term “silicon steel” includes the material commonly called “electrical silicon steel”.

While disclosed embodiments have been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

Additionally, it should be understood that the functionality described in connection with various described components of various embodiments may be combined or separated from one another in such a way that the architecture of the resulting system is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

As a result, it will be apparent for those skilled in the art that the illustrative embodiments described are only examples and that various modifications can be made within the scope of the invention as defined in the appended claims.

1. An apparatus comprising:
an electromagnetic device containing at least one layer of magnetizable material and at least one layer of electrically-insulating material,
wherein the magnetizable material layer is between less than 300 microns in thickness,
wherein a saturation magnetic induction of the magnetizable material is greater than 1.7 Tesla, and
wherein the at least one layer of magnetizable material is adjacent to at least one layer of electrically-insulating material.

2. The apparatus of claim 1, wherein the magnetizable layer is less than 100 microns in thickness.

3. The apparatus of claim 1, wherein the magnetizable layer is less than 10 microns in thickness.

4. The apparatus of claim 1, wherein the electromagnetic device is a transformer.

5. The transformer of claim 1, wherein the electromagnetic device includes a plurality of layers of magnetizable material including the at least one layer of magnetizable material, and wherein plurality of magnetic layers reduces eddy current core loss as compared to a transformer using silicon steel sheets with the thickness of 300 microns as a core material.

6. An electric motor including the apparatus described in claim 1, wherein the electromagnetic device includes a plurality of layers of magnetizable material including the at least one layer of magnetizable material, and wherein plurality of magnetic layers reduce eddy current core loss thereby increasing motor efficiency.

7. The apparatus of claim 1, wherein the magnetizable material is iron.

8. The apparatus of claim 1, wherein the magnetizable material is silicon steel.

9. The apparatus of claim 1, wherein the magnetizable material is Fe—P alloy.

10. A method of constructing a magnetic core through successive deposition of one or more layers of magnetizable material at least one of which being between 1 nanometer and 300 microns thick,
wherein, a saturation magnetic induction of the magnetizable material is greater than 1.7 Tesla, and
wherein at least two magnetic layers are electrically insulated from one another by deposition of at least one material that is between 1 nanometer and 300 microns thick.

11. The method of claim 10, wherein the magnetizable material is iron.

12. The method of claim 10, wherein the magnetizable material is silicon steel.

13. The method of claim 10, wherein the magnetizable material is Fe—P alloy.
